(19) United States
(12) Patent Application Publication
(10) Pub. No.: US 2010/0100904 A1
(43) Pub. Date: Apr. 22, 2010

(54) COMMENT DISTRIBUTION SYSTEM, COMMENT DISTRIBUTION SERVER, TERMINAL DEVICE, COMMENT DISTRIBUTION METHOD, AND RECORDING MEDIUM STORING PROGRAM

(75) Inventors: Nobuo Kawakami, Tokyo (JP); Akihiko Koizuka, Koshigaya-shi (JP)

Correspondence Address: CANTOR COLBURN, LLP, 20 Church Street, 22nd Floor, Hartford, CT, 06103, US

(73) Assignee: DWANGO CO., LTD., Tokyo (JP)

(21) Appl. No.: 12/528,420

(22) PCT Filed: Feb. 29, 2008
(86) PCT No.: PCT/JP2008/053623

§ 371 Date: Aug. 24, 2009

(30) Foreign Application Priority Data
Mar. 2, 2007 (JP) 2007-053348

(51) Int. Cl. H04N 5/445; H04N 7/173

(52) U.S. Cl. 725/37; 725/109

(57) ABSTRACT

A comment distribution server includes: a first comment information storage unit that stores comment information including a comment assignment time that is a point of time when comment data is assigned shown by an elapse time from a dynamic image reproduction start time; and the comment data, and being correlated with the dynamic image data, and a comment information distribution unit that reads out a plurality of the comment information, and that distributes them to a terminal device. The terminal device includes: a dynamic image reproduction unit that receives and reproduces the dynamic image data distributed from a dynamic image distribution server; a comment information reception unit that receives the plurality of the comment information correlated with the dynamic image, from the comment distribution server; and a display unit that displays the dynamic image reproduced by the dynamic image reproduction unit, that reads out comment data correlated with a point of time shown by the comment assignment time, from the plurality of the comment information, and that displays the read out comment data along with the dynamic image.

### TECHNICAL FIELD

The present invention relates to a comment distribution system, a comment distribution server, a terminal device, a comment distribution method, and a recording medium storing a program which can perform inter-user communications while reproducing a dynamic image content, utilizing the content being reproduced.

Priority is claimed on Japanese Patent Application No. 2007-53348, filed Mar. 2, 2007, the content of which is incorporated herein by reference.

### BACKGROUND ART

Heretofore, for example, there has been a system that displays a comment stated by a user on a dynamic image such as broadcasted television program, along with the dynamic image.

For example, there is a system in which on a bulletin board related to such as a television program that is broadcasted in different hours in each region, a comment post to one scene of the television program is correlated with the net time from the start of broadcasting and stored, and even if the time of viewing the bulletin board is different, the previously posted content is displayed in time with the scene of the television program (for example, refer to Patent Document 1). According to this system, a user would not feel a time lag of broadcasting time, and can enjoy comment viewing while watching the television program.

### [Patent Document 1] Japanese Unexamined Patent Application, First Publication No. 2002-290949

### DISCLOSURE OF INVENTION

### Problem to be Solved by the Invention

However, the system of the conventional technique described above has a problem in that if the number of comments becomes large, all of the comments cannot be displayed, and consequently if the number of comments to be displayed is limited, for example, to the most recently posted 100 cases, only uninteresting comments may be displayed while there were interesting comments in the past.

The present invention takes into consideration the above circumstances, and an object thereof is to provide a comment distribution system, a terminal device, a comment distribution server, a comment distribution method, and a recording medium storing a program which can display interesting comments even if a large number of comments are posted.

### Means for Solving the Problem

The present invention has been conceived to solve the problem described above. A comment distribution system according to the present invention includes: a dynamic image distribution server that distributes dynamic image data; a comment distribution server that distributes a comment on a dynamic image; and a terminal device, and the comment distribution server includes: a first comment information storage unit that stores comment information including: a comment assignment time that is a point of time when comment data is assigned shown by an elapse time from a reproduction start time of the dynamic image data; and the comment data, and being correlated with the dynamic image data; and a comment information distribution unit that reads out a plurality of the comment information stored in the first comment information storage unit, and that distributes the plurality of the comment information to the terminal device, and the terminal device includes: a dynamic image reproduction unit that receives and reproduces the dynamic image data distributed from the dynamic image distribution server; a comment information reception unit that receives the plurality of the comment information correlated with the dynamic image to be reproduced, from the comment distribution server; a second comment information storage unit that stores the plurality of the comment information received by the comment information reception unit; and a display unit that displays the dynamic image reproduced by the dynamic image reproduction unit, that reads out comment data correlated with a point of time shown by the comment assignment time, from the plurality of the comment information stored in the second comment information storage unit, and that displays the read out comment data along with the dynamic image.

Moreover, the comment distribution system according to the present invention may be such that in the comment distribution system described above, the plurality of the comment information include comment information and master comment information correlated with the comment information, and the comment information distribution unit of the comment distribution server reads out all comment data included in the master comment information stored in the first comment information storage unit, distributes the comment data to the terminal device, extracts a predetermined number of comment data from the comment data included in the comment information stored in the first comment information storage unit, and distributes the predetermined number of comment data to the terminal device.

Moreover, the comment distribution system according to the present invention may be such that in the comment distribution system described above, the comment distribution server includes: a master comment setting unit that extracts specified comment data from the comment information to generate the master comment information, and that stores the master comment information into the first comment information storage unit.

Moreover, the comment distribution system of the present invention may be such that in any one of the comment distribution systems described above, the terminal device includes: a transmission unit that receives an input of a comment content on the dynamic image displayed by the display unit, and that transmits a point of time when the comment content is input as a comment assignment time shown by an elapsed time from a reproduction start time of the dynamic image, along with the comment content, as comment information, to the comment distribution server, and the comment distribution server includes: a comment information update management unit that adds, every time when comment information is transmitted from the transmission unit of the terminal device, the comment information to the comment information in the first comment information storage unit.

Moreover, a comment distribution server according to the present invention distributes a comment on a dynamic image, and includes: a comment information storage unit that stores comment information including: a comment assignment time that is a point of time when comment data is assigned shown by an elapse time from a reproduction start time of the dynamic image data, and the comment data, and being correlated with the dynamic image data; and a comment information distribution unit that reads out and distributes a plurality of the comment information stored in the comment information storage unit.

Moreover, a terminal device according to the present invention receives and displays a dynamic image and a comment on the dynamic image, and includes: a dynamic image reproduction unit that receives and reproduces a distributed dynamic image data; a comment information reception unit that receives a plurality of comment information correlated with the dynamic image to be reproduced; a comment information storage unit that stores the plurality of comment information received by the comment information reception unit; and a display unit that displays the dynamic image reproduced by the dynamic image reproduction unit, that reads out comment data correlated with a comment assignment time showing a dynamic image reproduction elapse time of the reproduced dynamic image, from the plurality of comment information stored in the comment information storage unit, and that displays the read out comment data along with the dynamic image.

Furthermore a comment distribution method according to the present invention is for a comment distribution system including a dynamic image distribution server that distributes dynamic image data, a comment distribution server that distributes a comment on a dynamic image, and a terminal device, the method includes: a first step in which the comment distribution server reads out a plurality of comment information stored in a first comment information storage unit that stores the comment information including: a comment assignment time that is a point of time when comment data is assigned shown by an elapse time from a reproduction start time of the dynamic image data; and the comment data, and being correlated with the dynamic image data, and distributes the plurality of comment information to the terminal device; a second step in which the terminal device receives and reproduces the dynamic image data distributed from the dynamic image distribution server; a third step in which the terminal device receives the plurality of comment information correlated with the dynamic image to be reproduced, from the comment distribution server, and stores the plurality of received comment information into a second comment information storage unit; and a fourth step in which the terminal device displays the dynamic image reproduced in the second step, reads out comment data correlated with a point of time shown by the comment assignment time, from the plurality of comment information stored in the second comment information storage unit, and displays the read out comment data along with the dynamic image.

Moreover, a computer-readable recording medium according to a first aspect of the present invention, stores a program for making a computer included in a comment distribution server that distributes a comment on a dynamic image, function as: a comment information distribution unit that reads out and distributes a plurality of comment information stored in a comment information storage unit that stores the comment information including: a comment assignment time that is a point of time when comment data is assigned shown by an elapse time from a reproduction start time of the dynamic image data; and the comment data, and being correlated with the dynamic image data.

Moreover, a computer-readable recording medium according to a second aspect of the present invention, stores a program for making a computer included in a terminal device that receives and displays dynamic image data and a comment on the dynamic image data, function as: a dynamic image reproduction unit that receives and reproduces distributed dynamic image data; a comment information reception unit that receives a plurality of comment information correlated with the dynamic image to be reproduced and stores the plurality of comment information into a comment information storage unit; and a display unit that displays the dynamic image reproduced by the dynamic image reproduction unit, that reads out comment data correlated with a comment assignment time showing a dynamic image reproduction elapse time of the reproduced dynamic image, from the plurality of comment information stored in the comment information storage unit, and that displays the read out comment data along with the dynamic image.

### Effect of the Invention

According to the present invention, the comment information distribution unit of the comment distribution server distributes a plurality of comment information. Consequently, by always including interesting comment data at least in one of the comment information, even if there is no interesting comment data in the other comment information, the terminal device can display the interesting comment data.

### BRIEF DESCRIPTION OF THE DRAWINGS

FIG. 1 is a schematic conceptual diagram showing a configuration of a comment distribution system according to an embodiment of the present invention.

FIG. 2 is a schematic block diagram showing a configuration of a comment distribution server.

FIG. 3 is a diagram showing an example of data stored in a comment information storage unit.

FIG. 4 is a schematic block diagram showing a configuration of a terminal device.

FIG. 5 is a diagram showing an example of information displayed on a display device.

FIG. 6 is a diagram showing an example of information displayed on the display device.

FIG. 7A is a flow chart for describing an operation of the comment distribution server.

FIG. 7B is a flow chart for describing an operation of the comment distribution server.

FIG. 8A is a flow chart for describing an operation of the terminal device.

FIG. 8B is a flow chart for describing an operation of the terminal device.

### REFERENCE SYMBOLS

1 Dynamic image distribution server
2 Comment distribution server
3 Terminal device
21 Comment information storage unit
22 Comment information distribution unit
23 Comment information update management unit
24 Communication unit
25 Master comment setting unit
26 Master comment information distribution unit
31 Dynamic image reproduction unit
32 Comment information reception unit
33 Comment information storage unit
34 Display device
35 First display unit
36 Second display unit
37 Input unit
38 Selection unit
39 Production control unit
40 Transmission unit
41 Master comment information reception unit

### BEST MODE FOR CARRYING OUT THE INVENTION

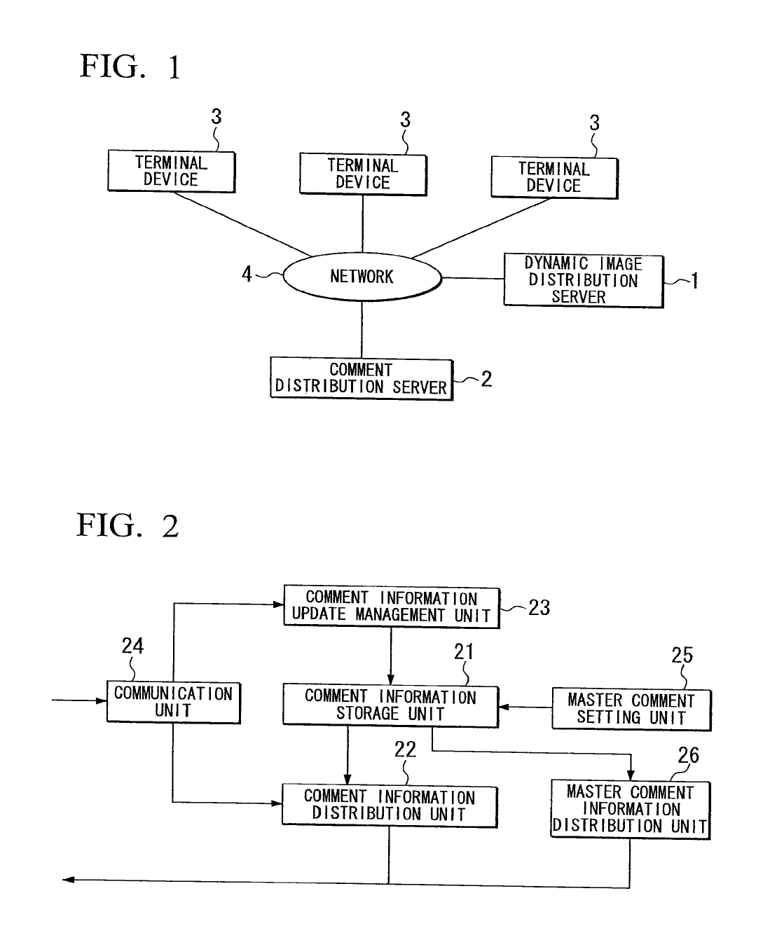

Hereunder, a comment distribution system according to an embodiment of the present invention is described, with reference to the drawings. FIG. 1 is a conceptual diagram showing a configuration of the comment distribution system according to the embodiment of the present invention. In this diagram, a dynamic image distribution server 1 distributes dynamic image data according to a distribution request from a terminal device 3. This distribution is performed, for example, through a streaming distribution. A comment distribution server 2 receives comments on a dynamic image distributed by the dynamic image distribution server 1, and distributes comment information and master comment information specified by a service administrator to each of the terminal devices 3 on which the dynamic image is being viewed. The terminal device 3 is connected, via a network 4, to the dynamic image distribution server 1 and the comment distribution server 2, and it receives and displays a dynamic image distributed from the dynamic image distribution server 1, while receiving comment information and master comment information distributed by the comment distribution server 2 and displaying them on the dynamic image.

Next, the comment distribution server 2 and the terminal device 3 in FIG. 1 are further described, with using the drawing. FIG. 2 is a schematic block diagram showing a configuration of the comment distribution server 2. In this diagram, a comment information storage unit 21 correlates the contents of the comment with an elapse time from the point in time of dynamic image reproduction start at which this comment content was assigned, as a comment assignment time, and it store them to the comment information. Furthermore, the comment information storage unit 21 stores, from among the comment information, master comment information (described later) including the comment content specified by the service administrator in particular.

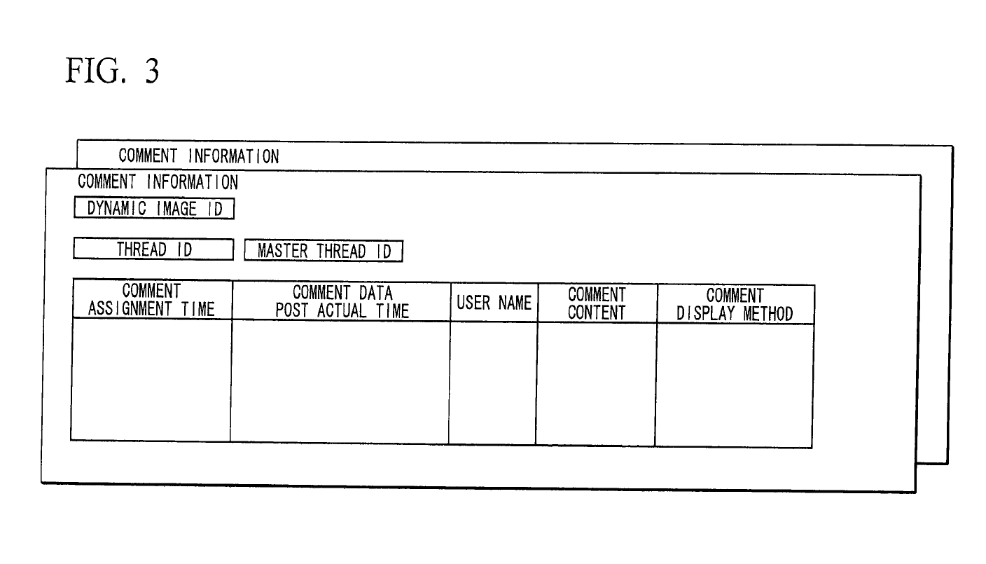

FIG. 3 shows an example of data stored in this comment information storage unit 21. In the comment information storage unit 21, there are stored a plurality of comment information in which comments on a dynamic image distributed by the dynamic image distribution server 1 are grouped for each thread. Each comment information includes a dynamic image ID for identifying a dynamic image and thread ID information for identifying a thread, so that it is possible to identify which thread is for which dynamic image. Furthermore, there is included a master thread ID which is a thread ID of a master thread with respect to the thread, so that when displaying comments of the thread, it is possible to always identify the thread to be displayed. Moreover in the comment information, there are included, in addition to the comment assignment time and comment content, a plurality of comment data correlated with a comment information post actual time (corresponding to the aforementioned actual time information) that indicates an actual point of time at which the comment was assigned (stated), a user name which is information for identifying the user that assigned the comment, and a comment display method that is information for specifying how comments are to be displayed on a dynamic image. In a case where the dynamic image of the dynamic image ID is being reproduced, and comment data is received from the terminal device 3 on which comments of the thread of the thread ID are being viewed, the received comment data is added and stored in the comment information storage unit 21. Here, the thread ID is stored while being correlated with the dynamic image ID, and it is thereby possible, even for the same dynamic image and even if there are provided a plurality of different threads, to identify them.

Here, a master thread refers to a thread including comments that are selected by the service administrator or the like from the comments posted in the past, and when comments of a given thread are to be displayed, the comment of the master thread of the thread is also displayed together. Hereunder, a comment of a master thread is referred to as a master comment, and comment information specified in the master thread is referred to as master comment information. The service administrator or the like can, by pre-specifying an interesting comment among the comments posted in the past as a master comment, display the interesting comment on the terminal device 3 even when the number of comments becomes large. The comment information storage unit 21 includes the master comment information also in a comment information format exemplary shown in FIG. 3. In the present embodiment, in the master comment information, the master thread ID is empty. However, the ID of another thread may be further set to the master thread ID to thereby display comments of the thread.

This comment information storage unit 21 corresponds to the first comment information storage unit.

Next, a comment information distribution unit 22 reads out the comment information stored in the comment information storage unit 21 and distributes it to the terminal device 3. At this time, the comment information distribution unit 22, in a case where the number of comments of the thread stored in the comment information storage unit 21 exceeds a certain number, reads out the comment information related to the certain number of the latest comment and distributes them to the terminal device 3. This certain number may be a preset constant number and may be a number determined based on the length of the correlated dynamic image. A comment information update management unit 23 adds and stores additional comment information received from the terminal device 3 via a communication unit 24 into the comment information storage unit 21 according to the dynamic image ID and thread ID.

A master comment setting unit 25, based on operating instructions from the service administrator, extracts a master comment from the comment stored in the comment information storage unit 21, makes the master comment into comment information of a new thread ID and stores it into the comment information storage unit 21. When performing this master comment extraction, a comment specified by an operating instruction, and a certain number of comments, the comment data post time of which is prior to this point, or comments, the comment data post time of which is within a certain period of time prior to this point, may be extracted as master comments. Also, a certain number of comments after this point or comments within a certain period of time after this point may be extracted as master comments. Moreover, the master comment setting unit 25 registers the thread ID of a generated master thread to the master thread ID of the original comment information from which the master comment has been extracted. A master comment information distribution unit 26 reads out, from the comment information storage unit 21, the comment information of the thread ID registered in the master thread ID of the comment information distributed from the comment information distribution unit 22, and distributes it to the terminal device 3 as master comment information.

The communication unit 24 performs various types of communications with the terminal device 3, and it outputs instructions to output information transmitted from the terminal device 3 to the comment information update management unit 23 so as to add and store comment information in it, and it outputs a comment information distribution instruction to the comment information distribution unit 22.

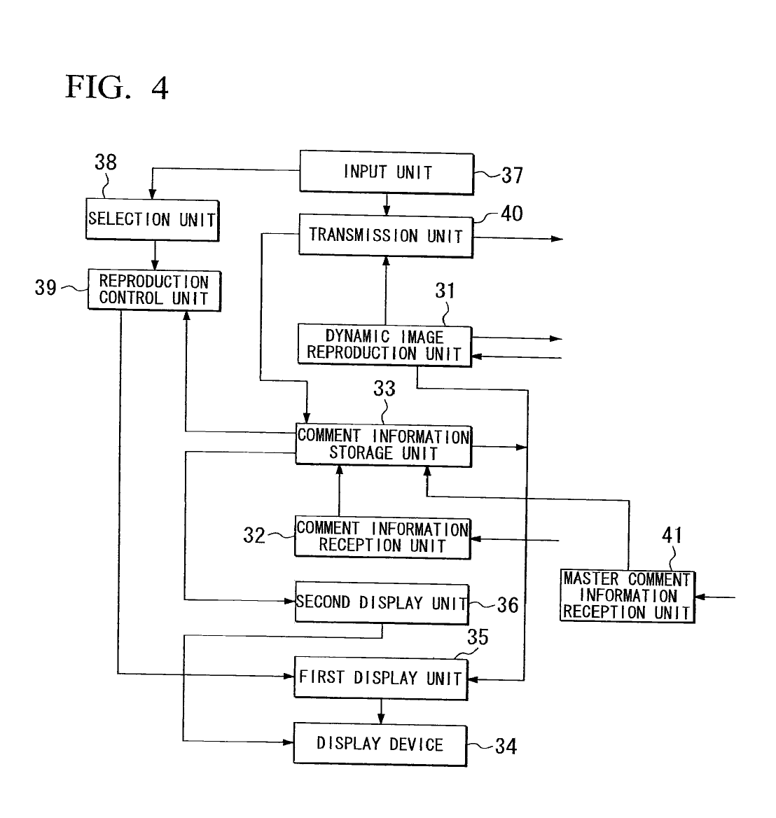

Next, the terminal device 3 is described, with using the drawings. FIG. 4 is a schematic block diagram for describing the configuration of the terminal device 3.

In this diagram, a dynamic image reproduction unit 31 transmits, to the dynamic image distribution server 1, a distribution request for a dynamic image specified by a user of the terminal device 3, and receives and reproduces the dynamic image distributed from the dynamic image distribution server 1. A comment information reception unit 32 receives, from the comment distribution server 2, comment information input for the dynamic image to be reproduced. A master comment information reception unit 41 receives, from the comment distribution server 2, the master comment information specified by the service administrator from among comments. A comment information storage unit 33 stores the comment information received by the comment information reception unit 32 and the master comment information received by the master comment information reception unit 41. This comment information storage unit 33 corresponds to the second comment information storage unit.

A display device 34 is such as a liquid crystal display device, a CRT (cathode ray tube), or the like, and it displays various types of information. A first display unit 35 displays, on the display device 34, an image of a plurality of layers being superimposed on the dynamic image to be reproduced by the dynamic image reproduction unit 31. That is to say, the first display unit 35 displays, on the display device 34, an image of superimposed three layers, namely: a layer for displaying the dynamic image to be reproduced by the dynamic image reproduction unit 31; a layer for displaying the read out comment by reading out, among the comment information stored in the comment information storage unit 33, the comment that is correlated with the comment assignment time for showing the dynamic image reproduction elapse time of the dynamic image to be reproduced; and a layer for displaying the read out comment by reading out, among the master comment information stored in the comment information storage unit 33, the comment that is correlated with the comment assignment time corresponding to the dynamic image reproduction elapse time of the dynamic image to be reproduced.

A second display unit 36, based on the comment data of the comment information and master comment information stored in the comment information storage unit 33, displays on the display device 34, a list of comments as a comment list. Here, they are displayed according to the order of the comment post actual time information included in the comment data.

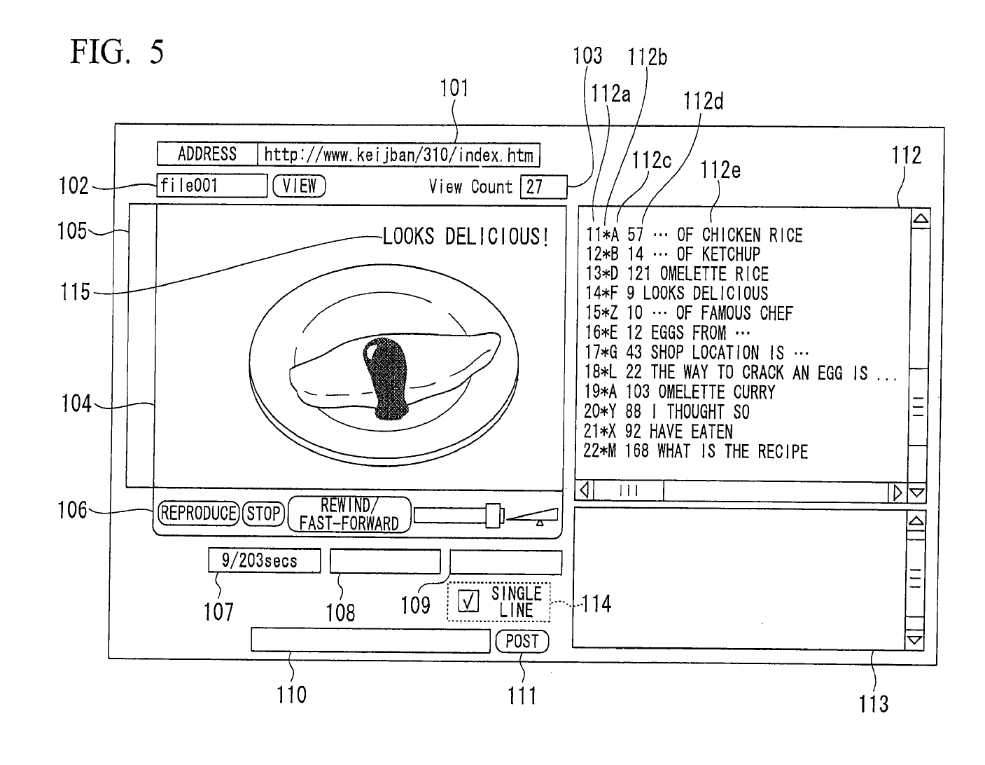

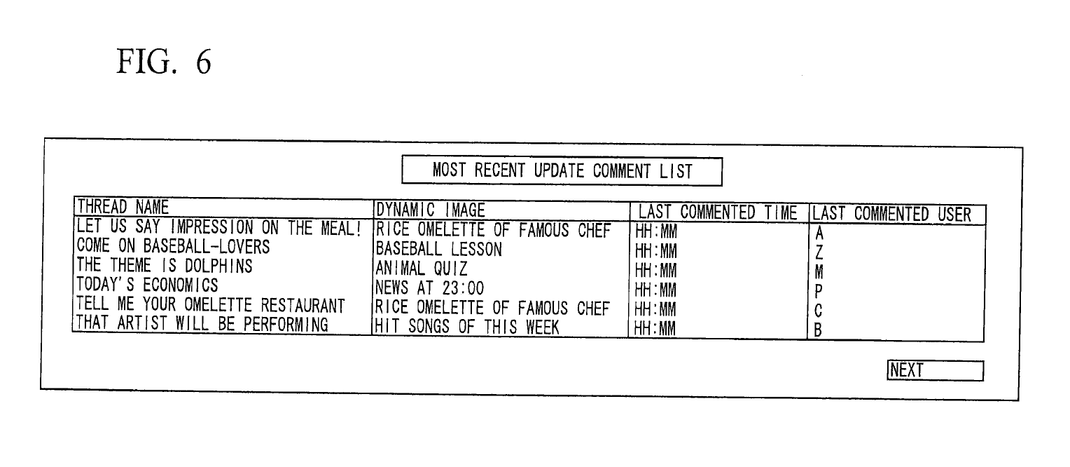

Information to be displayed on this display device 34 is further described. FIG. 5 is a diagram showing an example of information displayed on the display device 34. A display field 101 displays the URL (uniform resource locator) where this comment distribution server is accessed. A display field 102 displays a dynamic image ID of a dynamic image to be reproduced. A display field 103 displays, as a viewing frequency, the total number of viewing requests made for the currently displayed dynamic image. This viewing frequency is such that in a case where another user reproduces (requests viewing of) the dynamic image, the count number for the user currently viewing the same dynamic image at this point of time is increased, and the count number is updated and displayed. A display field 104 displays the dynamic image to be displayed by the first display unit. A display field 105 is a region in which a comment to be displayed by the second display unit is displayed, and here, the comment is displayed on the dynamic image displayed by the display field 104. Moreover, here the display field 105 is set with a size greater than that of the display field 104, and an overlay-displayed comment is trimmed on the outside of the screen of the dynamic image. Thus, it is possible to understand that the comment is not included in the dynamic image and has been posted by a user for the dynamic image.

An operation panel 106 displays a reproduction button, a stop button, a rewind button, a fast forward button, a sound volume adjustment button, and a reproduction status display field that indicates an approximate position of the entire dynamic image being currently reproduced. Any one of the buttons is clicked with the cursor aligned thereon with use of a mouse to thereby receive an operation input according to the button. A display field 107 displays the reproduction time length of an entire dynamic image and the dynamic image reproduction elapse time of the dynamic image being currently displayed in the display field 105. Into an input field 108, the name of a user that places a statement for the dynamic image is to be input via an input unit 37. Here, in the vicinity of the input field 108, there may be provided a check box so that whether or not an email address is to be input is selected according to whether or not this check box has been checked, and if the check box is checked, the input field 108 is increased to two so that inputs of the name and email address of the user may be received. To an input field 109 there is input information for specifying a manner in which comments are to be displayed. As for the manner of comment display, for example, as information to specify an overlay-display to be performed, it is possible to set: the position of the comment to be displayed on a dynamic image; the font; the character size; and the starting position and end position of a moving-display and the direction in which the moving display is to be performed. Here, it is possible that the comment display manner may be preliminarily decided so that the user is not required to perform an input.

To a comment field 110 a comment input from the user via the input unit 37 is input. A button 111 is clicked to thereby transmit, to the comment distribution server 2, a comment input in the comment field 110, a user name input in the input field 108, and a comment display manner information input in the input field 109. A display field 112 is a region in which there is displayed a comment list, which is a list of comments. In this comment list, there are displayed, according to the order of post actual time information, numbers indicating the order of statements assigned to the comments (reference symbol 112a), marks that indicate that they are master comments (reference symbol 112b), names of users that input comments (reference symbol 112c), comment assignment times at which the comments were posted (reference symbol 112d), and a part of the stated comments (reference symbol 112e). In this display field 112, it is possible that there may be provided an input field such as check box for specifying whether or not the display field 112 is to be displayed on the screen, and it may be displayed or hidden according to the instruction input in this input field of whether to allow or not to allow display. Moreover, the number of a part of comments to be displayed in this display field 112 may be changed according to user's instruction. A display field 113 displays the detail of the comment that the user aligns the cursor thereon among the list of comments displayed in the display field 112. For the detail of the comment, the entire comment, or the name or email address of the user that stated the comment is displayed.

A check box 114 is to specify, by having a check mark therein, that the comment to be input in the comment field 110 is a single line. For example, if a check mark has been input in the check box 114, an input of a comment is completed, and when the input is completed by pressing down, for example, the enter key, the “POST” button is considered to have been clicked at the point of time where the enter key was pressed down, and the comment is transmitted to the comment distribution server 2. Thereby, it is possible to quickly and easily input a comment.

Next, returning to FIG. 4, the input unit 37 is an input device such as mouse and keyboard, and receives inputs of various types of information from a user. A selection unit 38 receives an input of a comment selection input via the input unit 37 among the list of comments displayed by the second display unit 36. A reproduction control unit 39 reads out the comment data of the comment selected by the selection unit 38 from the comment information storage unit 33, makes the first display unit reproduce the dynamic image and display it on the display device 34 from the dynamic image reproduction elapse time displayed in the comment assignment time of the read out comment data, and makes the first display unit 35 display the comment content of the read out comment data on the display device 34.

A transmission unit 40 receives a data input of the comment content for the dynamic image displayed by the first display unit 35, and transmits, to the comment distribution server, the dynamic image reproduction elapse time, at which point of time the comment content was input, as the comment assignment time, along with the comment content. Moreover, the transmission unit 40 has a function to transmit various types of information to the comment distribution server 2 and the dynamic image distribution server 1 according to an instruction input from the input unit 37.

Next, an operation of the above comment distribution system is described. Here, first, an overview of the operation of the comment distribution system is described.

First, the terminal device 3 accesses the comment distribution server 2 to receive the data of a most recent update comment list having most recent comment post times, and displays them on the display device 34. At this time, for example, the display device 34 displays dynamic image names, thread names and so forth as the list of latest updated comments. Here, if the user selects a thread to view and the name of the thread is clicked with the mouse, the terminal device 3 will transmit, to the dynamic image distribution server 1, the dynamic image ID set on the dynamic image correlated with the clicked thread to perform a dynamic image distribution request, while transmitting the thread ID and the dynamic image ID set for the clicked thread, to the comment distribution server 2 to request a transmission of the comment information. In response to this, the dynamic image distribution server 1 streaming-distributes the dynamic image specified by the dynamic image ID to the terminal device 3 that requested the distribution. On the other hand, the comment distribution server 2 reads out the comment information correlated with the thread ID and the dynamic image ID, and the master comment information of this comment information, from the comment information storage unit 21, and distributes them to the terminal device 3 that requested the distribution.

The terminal device 3 receives the dynamic image distributed from the dynamic image distribution server 1 and displays it on the display device 34, while displaying the comment content on the dynamic image, based on the comment information and the master comment information distributed from the comment distribution server 2. Here, in time with the dynamic image reproduction elapse time from the start of the dynamic image reproduction, the comment content, to which the comment assignment time matching with the dynamic image reproduction elapse time is set, is sequentially displayed on the dynamic image.

Next, the operations of the comment distribution server 2 and the terminal device 3 are described in order.

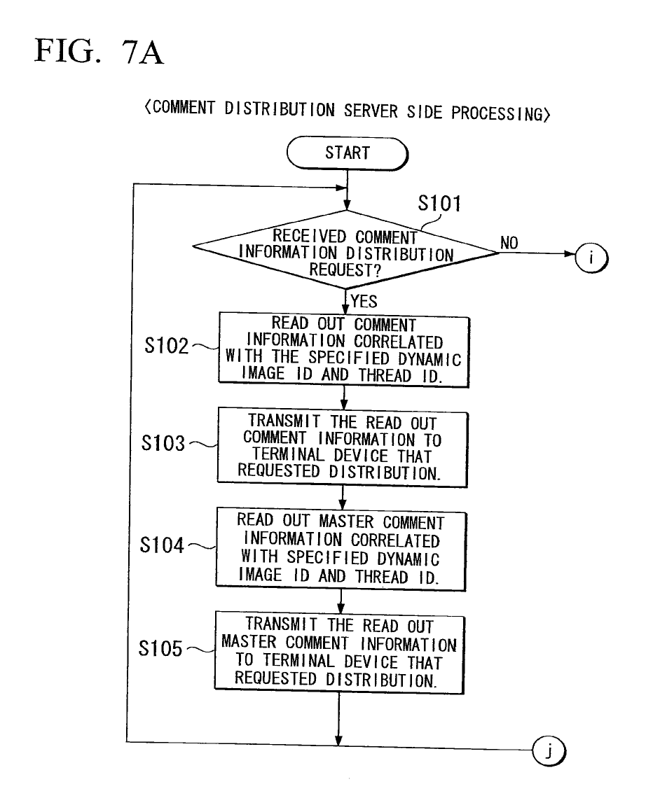

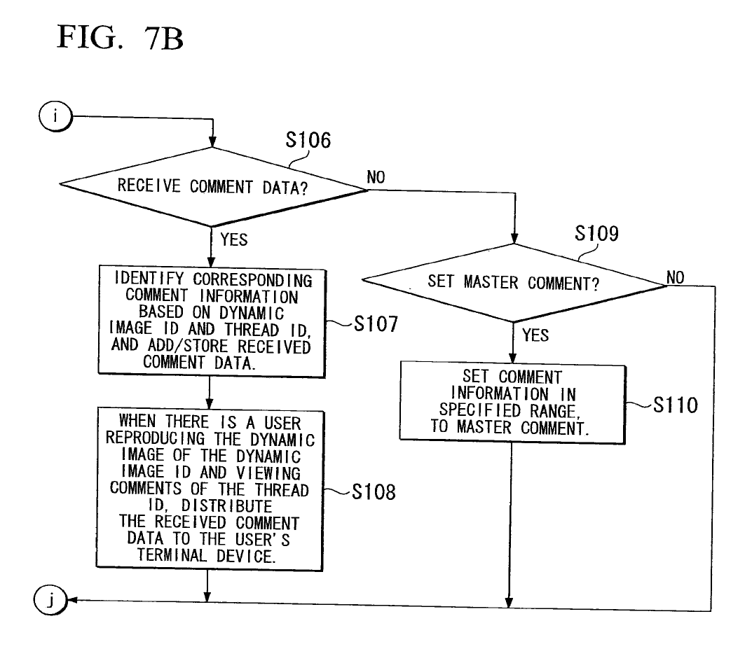

First, the operation of the comment distribution server 2 is described, with using the flow charts of FIG. 7A and FIG. 7B.

The communication unit 24 of the comment distribution server 2 detects whether or not a comment information distribution request has been received from the terminal device 3 (step S101). In a case where a comment information distribution request has been received, the communication unit 24 instructs the comment information distribution unit 22 to perform a comment information distribution. Here, a dynamic image ID and thread ID of the comment information included in the distribution request are output to the comment information distribution unit 22. The comment information distribution unit 22 reads out, from the comment information storage unit 21, the comment information correlated with the dynamic image ID and thread ID output from the communication unit 24 (step S102), and distributes the read out comment information to the terminal device 3 that has requested the distribution (step S103). Here, the respective comment information correlated with the dynamic image ID and the thread ID are transmitted in a batch.

Furthermore, the comment information distribution unit 22 reads out the master thread ID of the distributed comment information, and requests the master comment information distribution unit 26 to distribute the master comment information of the read out master thread ID. The master comment information distribution unit 26, which has received this master thread ID, reads out, from the comment information storage unit 21, the comment information with the received master thread ID serving as its thread ID (step S104), and distributes the read out master comment information to the terminal device 3 (S105).

On the other hand, in a case where comment data transmitted from the terminal device 3 has been received instead of the comment information distribution request determined in step S101 (step S106), the communication unit 24 outputs the comment data to the comment information update management unit 23. The comment information update management unit 23 makes reference to the comment information storage unit 21, and identifies the comment information based on the dynamic image ID and thread ID included in the comment data output from the communication unit 24, and adds and stores the received comment data to the identified comment information (step S107). When the comment data has been added and stored, the comment information distribution unit 22 identifies the terminal devices 3 that are reproducing the dynamic image of the dynamic image ID and that are viewing the comment of the thread ID along with the dynamic image of the dynamic image ID, and it distributes, to each of the identified terminal devices 3, the comment data that has been added and stored (step S108). Here, a method for identifying the terminal devices 3 that are reproducing the dynamic image of the same dynamic image ID and that are viewing the thread comment of the thread ID, may be such that for example, having established a session with the terminal device 3 that has accessed the comment distribution server 2, the terminal device 3 for which this session is valid is identified as the terminal device 3 viewing the dynamic image.

On the other hand, if a master comment setting operation has been received in a case where there is no comment information distribution request that is determined in step S101, and the comment data transmitted from the terminal device 3 determined in step S106 has not been received either (S109), the master comment setting unit 25 extracts, from the comments stored in the comment information storage unit 21, a comment within a specified range as a master comment, and turns this into comment information of a new thread ID to be stored in the comment information storage unit 21 (S110).

In a case where there is no comment information distribution request that is determined in step S101, no comment data determined in step S106 has been received, and there is no master comment setting operation determined in step S109, the processing returns to step S101.

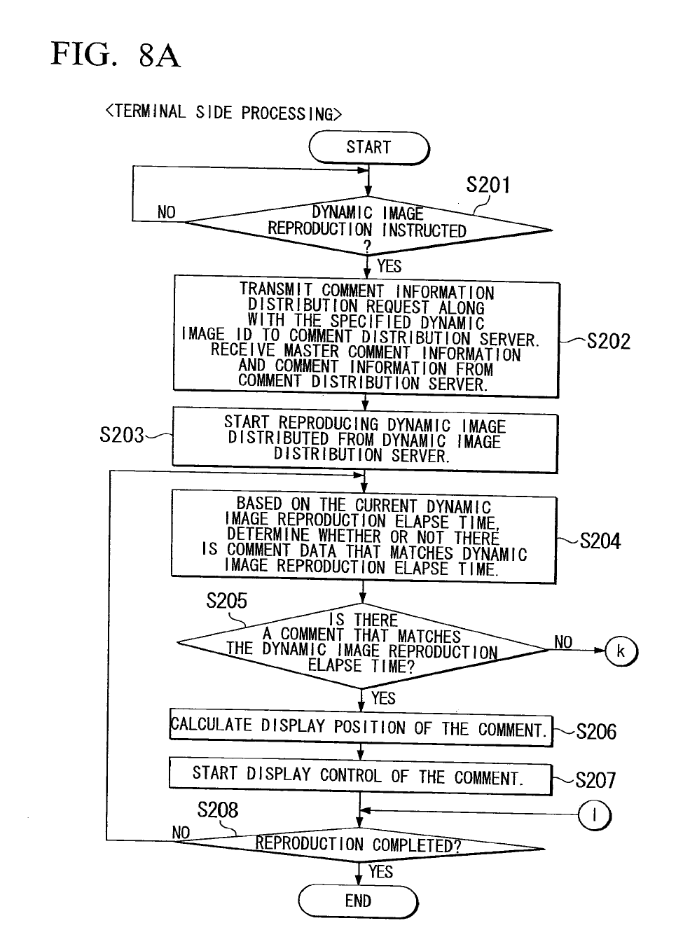

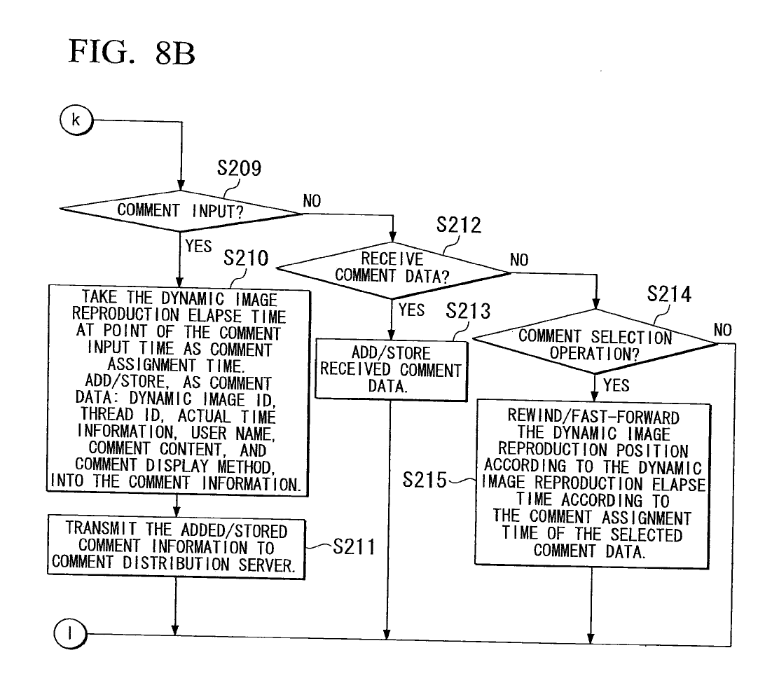

Next, an operation of the terminal device 3 is described, with using the drawings. FIG. 8A and FIG. 8B are flow charts for describing the operation of the terminal device 3.

Having received an input of a dynamic image reproduction instruction from the user (step S201), the input unit 37 of the terminal device 3, through the transmission unit 40, transmits the dynamic image ID of the instructed dynamic image to the dynamic image distribution server 1 to request a dynamic image distribution, and transmits a comment information distribution request to the comment distribution server 2. The comment information reception unit 32, if it has received comment information from the comment distribution server 2, stores it into the comment information storage unit 33. Moreover, the master comment information reception unit 41, if it has received master comment information distributed from the comment distribution server 2, stores it into the comment information storage unit 33 (step S202).

When the comment information and master comment information have been received and stored in the comment information storage unit 33, the dynamic image reproduction unit 31 receives the dynamic image distributed from the dynamic image distribution server 1, reproduces the received dynamic image, and makes the first display unit 35 display the layer of this dynamic image on the display device 34 (step S203). When reproduction of the dynamic image has been commenced, the first display unit 35 makes reference to the comment information and the master comment information in the comment information storage unit 33 to determine, based on the current dynamic image reproduction elapse time, whether or not there are any comment data to which a comment assignment time that matches the dynamic image reproduction elapse time is set (step S204). In a case where there is comment data to which the comment assignment time that matches the dynamic image reproduction elapse time is set (step S205—YES), the first display unit 35 calculates a display position of the comment data (step S206). According to the calculated display position, a comment display control is performed for the comment information layer and the master comment information layer that are superimposed on the dynamic image layer (step S207). At this time, depending on whether or not the comment data is a master comment, the font, color, character size, display position, moving speed (described later), and so forth may be changed.

On the other hand, the dynamic image reproduction unit 31 determines whether or not the reproduction has been completed, and if the reproduction has been completed, the processing will terminate, and if the reproduction has not been completed, the processing shifts to step S204.

On the other hand, in step S205, if there is no comment to be displayed, the transmission unit 40 detects whether or not a comment has been input from the input unit 37 (step S209). In a case where there has been a comment input, there is read out a reproduction time (dynamic image reproduction elapse time) at the point of time where the comment was input (at the point of time where the “POST” button 111 was clicked, for example), indicated by the player of a software that is reproducing the dynamic image. With the dynamic image reproduction elapse time as the comment assignment time, the dynamic image ID of the dynamic image currently being reproduced, the thread ID of the currently viewed comment, the current actual time information (current time information), the user name of the user of the terminal device 3, the content of the input comment, and the comment display method, are correlated and added to and stored as comment information into the list of comments of the comment information storage unit 33 (step S210). The transmission unit 40 transmits the added and stored comment information to the comment distribution server 2 (step S211), and the processing shifts to step S208.

In step 5209, if there is no comment input, the terminal device 3 makes the comment information reception unit 32 detect whether or not comment data has been received (step S212). In a case where comment data has been received, the comment information reception unit 32 adds and stores the received comment data into the comment information storage unit 33 (step S213), and the processing shifts to step S208.

On the other hand, in step S212, in a case where no comment data has been received, the selection unit 38 of the terminal device 3, through the input unit 37, detects whether or not there has been an input of a comment selection operation (step S214). In a case where there has been an input of a comment selection operation, the selection unit 38 outputs the comment content of the selected comment data to the reproduction control unit 39. Having received this output, the reproduction control unit 39 makes reference to the comment information storage unit 33 to read out the comment assignment time stored in a state of being correlated with the selected comment data, and according to the dynamic image reproduction elapse time corresponding to the read out comment assignment time, it rewinds or fast-forwards the dynamic image reproduction position, and thereby, a reproduction is performed from the dynamic image reproduction elapse time that matches the comment assignment time stored in a state of being correlated with the comment data (step S215), and the comment content of the comment assignment time is displayed. Then, the processing shifts to step S208.

Next, there is described a case where a comment is displayed on the screen, with using the drawing. Here, there is described a case where in “RECENT COMMENT LIST” in FIG. 5, a thread “LET US SAY IMPRESSION ON THE MEAL!” correlated with a dynamic image “RICE OMELET OF FAMOUS CHEF” has been selected. If this thread is selected, the dynamic image of “RICE OMELET OF FAMOUS CHEF” is reproduced, for example, within the region of the display field 104 of FIG. 5. Then comments are displayed in order on the dynamic image according to dynamic image reproduction elapse times. FIG. 5 shows the screen at the point of time where the dynamic image reproduction elapse time is 9 seconds, and here, a comment “LOOKS DELICIOUS!” from a user F is displayed while moving from the right side to the left side of the screen (reference symbol 115).

In the embodiment described above, there has been described a case where when a comment has been added to the list of comments and the added comment is clicked by a user, reproduction is performed from the dynamic image reproduction elapse time that matches the comment assignment time set to the comment, and the comment is displayed. If the added comment is not clicked, the comment is displayed on the dynamic image at the point of time where the dynamic image reproduction elapse time has reached the comment assignment time set to the added comment.

Moreover, even if another user posts a comment to the dynamic image being currently displayed to oneself, it is displayed in the list of comments in the order of actual time. Consequently, it is possible to view the comment by clicking the added comment to rewind or fast-forward the dynamic image to the point of time where the comment was posted. Moreover, here, by rewinding the dynamic image, the comments posted up until this point of time, including the newly posted additional comment, are displayed in order corresponding to the comment assignment times thereof, according to the dynamic image reproduction elapse time.

Moreover, here it is possible to rewind and fast-forward the reproduction time by moving a slide bar in the reproduction status display field of the operation panel 106. However with this operation, the dynamic image is rewound or fast-forwarded, and the comment required for viewing may immediately disappear from the screen and may not be found easily in some cases. However, it is possible to start viewing from the required scene by selecting it from the list of comments.

Furthermore, in the embodiment described above, there has been described a case where the comment data distributed from the comment distribution server 2 is received by the terminal device 3 and is reflected and displayed on the screen. However, on the terminal device 3 of oneself, the comment input by a user may be immediately displayed on the screen at the point of time where the comment has been input (before transmitted to the comment distribution server 2 and received on the comment distribution server 2 side). Specifically, it may be performed such that when a comment has been input in step S209 in FIG. 8B, the input comment is displayed on the terminal device 3 of oneself, the processing shifts to step S210, the input comment is added and stored on the list of comments, and then it is transmitted to the comment distribution server 2.

Next, displaying of a comment is described.

Setting of an input comment is possible by inputting, into the input field 109, the display position thereof such as upper area, middle area, and lower area of the screen, and the display time for which the comment is to be displayed while moving. Moreover, in a case of setting the display time, for example, a comment may be displayed on the upper area of the screen for a certain period of time (4 seconds, for example), and may then be removed. Moreover, it is also possible to specify a period of time during which the comment appears within the display region of the screen and moves to the outside of the region (4 seconds, for example), to thereby adjust the movement speed. Furthermore, in a case or the like where a large number of comment inputs are made and are concentrating at a certain dynamic image reproduction elapse time, and they are overlapped on each other on a line with the same height if they are displayed, it is possible to change the height on the screen to display or moving-display them. Moreover, in a case where the display time is set and the movement speed consequently differs depending on the length of the character string of comments, a next comment may catch up before the movement of the comment has completed in some cases. Therefore, also in such case, the next comment may be displayed or moving-displayed on a line at a different height.

Moreover, as for a comment, it is also possible not only to input a sentence, but also to arrange characters and symbols, and the like to thereby input an ASCII art (also called text art) as a comment. In this case, the check of “SINGLE LINE” of the check box 114 is removed, and characters and symbols are scripted in several lines, and it is thereby possible to draw a landscape graphic or a realistic image. Here, in order to fit all lines of the ASCII art within the screen, the character font may be expanded or shrunk as necessary.

Moreover, based on actual times, new and old comments may be determined, and a comment input made at an old point of actual time may be translucently displayed after having been displayed for a certain period of time, and it may then be removed. Furthermore, an importance level may be set to a comment, and the character size of the comment may be changed according to the level of its importance. For example, a comment having a greater number of response comments may be determined as having a greater level of importance, and the character size of the root comment may be increased. Moreover, a comment display position in the vertical direction (vertical direction on the screen) may be changed according to the level of importance. For example, a comment at a greater level of importance may be displayed on a line in the upper area of the screen, and a comment at a lower level of importance may be displayed on a line in the lower area of the screen.

In the embodiment described above, there has been described a case where the dynamic image server 1 and the comment distribution server 2 are separate servers. However, the functions of the dynamic image distribution server 1 and the comment distribution server 2 may be realized on the same server.

In the embodiment described above, there has been described a case where when viewing comments and a dynamic image on the present service, the comment distribution server 2 is accessed to receive data of a most recent updated comment list, and a dynamic image and thread are selected from the most recent updated comment list displayed on the display device 34. However, this dynamic image and the thread may be specified and a URL that allows viewing of comments and the dynamic image may be created to be published on the Internet. Specifically, a URL that contains a dynamic image ID and a thread ID and that, when clicked, enables reproduction of the dynamic image and reception of the comment information of the thread, may be posted to a blog or a bulletin board on a website of the Internet for other users to click. Moreover, such a URL may be pre-set in a thumbnail image to be clicked.

Furthermore, in the embodiment described above, there has been described a case where when viewing comments and a dynamic image on the present service, the comment distribution server 2 is accessed to receive data of a most recent updated comment list, and a dynamic image and thread are selected from the most recent updated comment list displayed on the display device 34. Viewing of comments and a dynamic image may be such that data of a master thread list is received and a dynamic image and a master thread are selected from the master thread list displayed on the display device 34, to thereby perform viewing of the dynamic image and comments, and perform comment input. In this case, the input comment is registered on a new thread, and consequently there will be generated a plurality of threads that takes a certain thread as its master thread.

Moreover, data of a comment list of a thread that takes the thread as its master thread from the master thread list may be received from the comment distribution server 2, and the dynamic image and thread may be selected from this comment list displayed on the display device 34, to thereby perform viewing of the dynamic image and comments, and perform comment input.

Furthermore, for such a recent comment list, on the screen where a dynamic image and comments are being viewed (for example, FIG. 5), on the right side or lower side of the screen, there may be displayed a thumbnail image or there may be displayed a ranking of thread having a large number of accesses, for a user to click thereon, so that a thread that is set in the clicked thumbnail image may be displayed.

Moreover, in the embodiment described above, there has been described a case where a dynamic image ID and a thread ID are specified. However, a representative thread ID may be preliminarily registered for the dynamic image ID, so that when only the dynamic image ID is specified, the representative thread is displayed. Furthermore, in a case where simply a comment input has been made for a dynamic image without specifying a thread on which the comment was about to be posted, it may be posted on the representative thread. Furthermore, in a case where a certain number (for example, 100) of comments have been stated on a thread, the comment distribution server 2 or a user may generate a new thread.

Moreover, the comment list may be such that a comment that has been displayed once on a dynamic image, or a comment from the comment list that a user has clicked and viewed, can be identified, on the comment list, as a comment that has been viewed. For example, the color of characters may be changed, or there may be displayed a mark indicating that it has been viewed.

Furthermore, an individual user identifier may be assigned to each user, and for example, the user identifier may be correlated with a comment, treating them as comment data. Thereby, it is possible to identify who stated the comment. Furthermore, a comment may be displayed in a different character color according to a user identifier. Thereby, it is possible to identify the user that stated the comment.

Moreover, a user ID may be preliminarily allocated to a user that has accessed to the system, and this user ID may be included in the comment data to be stored, so that the comment stated by each user can be list-displayed, for example, in a pop-up display or the like. This user ID may be allocated to each user by preliminary user registration, and information that identifies a terminal device may be used therefor. In a case of using this information that identifies a terminal device, for example, a calculation may be performed on the information that identifies the terminal device, using a hash function, and the calculation result may be used as a user ID.

Moreover, a delete button may be provided on the screen shown in FIG. 5 displayed on the terminal device 3, so that if a user selects a comment on the comment list displayed in the display field 112 and further presses the delete button, the terminal device 3 receives an instruction for the operation and a request for deleting the comment is transmitted to the comment distribution server 2. In this case, having received the comment deletion request, the comment distribution server 2 sets a non-display flag on the comment stored in the comment information storage unit 21, and transmits a request for deleting the comment to the terminal device 3 that is viewing comments of the thread. The terminal device 3 that has received this then deletes the corresponding comment data from the comment information storage unit 33. Moreover, from this point on, the comment distribution server 2, when distributing comment information to the terminal device 3, does not distribute the comment data of the comment having the non-display flag set thereon. Alternatively, even if the comment having the non-display flag set thereon is received, the terminal device 3 does not display this.

Furthermore, user management may be performed on the comment distribution server 2, so that for this comment deletion request, only requests from a user that manages the thread containing the target comment are accepted by the comment distribution server 2.

Moreover, a single dynamic image can have a plurality of threads. Therefore threads may be divided by languages such as Japanese, English, and Korean. The terminal device 3 may display buttons that allow to select a thread of each of these languages, and a layer of the thread of the language switched by user's operating instruction may be superimposed on the dynamic image layer and displayed. Furthermore, when a plurality of threads of each of these languages are selected, each layer of the selected plurality of languages may be superimposed and displayed.

Moreover, in the present embodiment, the master comment has been described such that the comment data specified by the service administrator is extracted by the master comment setting unit 25 of the comment distribution server 2 to thereby generate master comment information. However, the information that indicates the comment data specified from the terminal device 3 by a user may be received by the master comment setting unit 25 of the comment distribution server 2, and the master comment setting unit 25 may generate master comment information. Furthermore, in this case, the comment distribution server 2 may register and manage user IDs, and only a user that manages each thread may be allowed to instruct generation of the master comment information of the thread.

Furthermore, in the present embodiment, the master comment information has been described as having a data format similar to that of the comment information. However, it may be information referring to the comment information, by thread ID and comment data post actual time, or the like.

Moreover, in the present embodiment, the master comment information has been described as being extracted and generated, by the master comment setting unit 25, from comment information. However, the comment data directly input to the master comment setting unit 25 may be stored in the comment information storage unit 21 as master comment information.

Thus, the comment information distribution unit 22 of the comment distribution server 2 distributes comment information, while the master comment information distribution unit 26 distributes master comment information correlated with the comment information, and the display device 34 of the terminal device 3 displays, along with a dynamic image, comment data included in these comment information and master comment information. Therefore, by registering interesting comment data in the master comment information, even in a case where the number of posted comments is large and consequently interesting comment data is not included in the comment information, the terminal device 3 can still display interesting comment data.

Moreover, in the embodiment described above, a program for realizing the functions of the comment information distribution unit 22, the comment information update management unit 23, the communication unit 24, the master comment setting unit 25, and the master comment information distribution unit 26 in FIG. 2, or a program for realizing the functions of the dynamic image reproduction unit 31, the comment information reception unit 32, the first display unit 35, the second display unit 36, the input unit 37, the selection unit 38, the reproduction control unit 39, the transmission unit 40, and the master comment information reception unit 41 in FIG. 4, may be stored on a computer-readable recording medium, and the program stored on this recording medium may be loaded and executed on a computer system to thereby perform a comment distribution and comment display control. Here, the “computer system” includes an operating system and hardware such as peripheral devices.

Moreover, the “computer system” includes, in a case of using a WWW system, a homepage-providing environment (or displaying environment).

Furthermore, the “computer-readable recording medium” refers to a portable medium such as flexible disk, magnetic optical disk, ROM, and CD-ROM, and to a memory device built into a computer system such as a hard disk. Furthermore, the “computer-readable recording medium” includes one that dynamically retains a program for a short period of time, such as a communication line in a case of transmitting the program through a network such as the Internet and through a communication line such as a telephone line, and it also includes one that retains the program for a certain period of time, such as volatile memory in a computer system serving as a server or a client in this case. Moreover, the above program may be for realizing a part of the functions described above, and may be one that can realize the functions described above, in combination with a program that has already been stored on a computer system.

The embodiment of the present invention has been described in detail, with reference to the drawings. However, the specific configuration is not limited to this embodiment, and there may be included designs and so forth that do not depart from the scope of the present invention.

### INDUSTRIAL APPLICABILITY

The present invention is suitably used for a comment distribution system in which comments are assigned to dynamic image streaming distribution through the Internet, however, it is not limited to this.

1. A comment distribution system comprising:
a dynamic image distribution server that distributes dynamic image data;
a comment distribution server that distributes a comment on a dynamic image; and
a terminal device,
wherein the comment distribution server comprises:
a first comment information storage unit that stores comment information including: a comment assignment time that is a point of time when comment data is assigned shown by an elapse time from a reproduction start time of the dynamic image data; and the comment data, and being correlated with the dynamic image data; and
a comment information distribution unit that reads out a plurality of the comment information stored in the first comment information storage unit, and that distributes the plurality of the comment information to the terminal device, and
wherein the terminal device comprises:
a dynamic image reproduction unit that receives and reproduces the dynamic image data distributed from the dynamic image distribution server;
a comment information reception unit that receives the plurality of the comment information correlated with the dynamic image to be reproduced, from the comment distribution server;
a second comment information storage unit that stores the plurality of the comment information received by the comment information reception unit; and
a display unit that displays the dynamic image reproduced by the dynamic image reproduction unit, that reads out comment data correlated with a point of time shown by the comment assignment time, from the plurality of the comment information stored in the second comment information storage unit, and that displays the read out comment data along with the dynamic image.

2. The comment distribution system according to claim 1,
wherein the plurality of the comment information include comment information and master comment information correlated with the comment information, and
wherein the comment information distribution unit of the comment distribution server reads out all comment data included in the master comment information stored in the first comment information storage unit, distributes the comment data to the terminal device, extracts a predetermined number of comment data from the comment data included in the comment information stored in the first comment information storage unit, and distributes the predetermined number of comment data to the terminal device.

3. The comment distribution system according to claim 2, wherein the comment distribution server comprises: a master comment setting unit that extracts specified comment data from the comment information to generate the master comment information, and that stores the master comment information into the first comment information storage unit.

4. The comment distribution system according to claim 2,
wherein the terminal device comprises: a transmission unit that receives an input of a comment content on the dynamic image displayed by the display unit, and that transmits a point of time when the comment content is input as a comment assignment time shown by an elapsed time from a reproduction start time of the dynamic image, along with the comment content, as comment information, to the comment distribution server, and
wherein the comment distribution server comprises: a comment information update management unit that adds, every time when comment information is transmitted from the transmission unit of the terminal device, the comment information to the comment information in the first comment information storage unit.

5. A comment distribution server that distributes a comment on a dynamic image, comprising:
a comment information storage unit that stores comment information including: a comment assignment time that is a point of time when comment data is assigned shown by an elapse time from a reproduction start time of the dynamic image data, and the comment data, and being correlated with the dynamic image data; and
a comment information distribution unit that reads out and distributes a plurality of the comment information stored in the comment information storage unit.

6. A terminal device that receives and displays a dynamic image and a comment on the dynamic image, comprising:
a dynamic image reproduction unit that receives and reproduces a distributed dynamic image data;
a comment information reception unit that receives a plurality of comment information correlated with the dynamic image to be reproduced;
a comment information storage unit that stores the plurality of comment information received by the comment information reception unit; and
a display unit that displays the dynamic image reproduced by the dynamic image reproduction unit, that reads out comment data correlated with a comment assignment time showing a dynamic image reproduction elapse time of the reproduced dynamic image, from the plurality of comment information stored in the comment information storage unit, and that displays the read out comment data along with the dynamic image.

7. A comment distribution method for a comment distribution system comprising a dynamic image distribution server that distributes dynamic image data, a comment distribution server that distributes a comment on a dynamic image, and a terminal device, the method comprising:
a first step in which the comment distribution server reads out a plurality of comment information stored in a first comment information storage unit that stores the comment information including: a comment assignment time that is a point of time when comment data is assigned shown by an elapse time from a reproduction start time of the dynamic image data; and the comment data, and being correlated with the dynamic image data, and distributes the plurality of comment information to the terminal device;
a second step in which the terminal device receives and reproduces the dynamic image data distributed from the dynamic image distribution server;
a third step in which the terminal device receives the plurality of comment information correlated with the dynamic image to be reproduced, from the comment distribution server, and stores the plurality of received comment information into a second comment information storage unit; and
a fourth step in which the terminal device displays the dynamic image reproduced in the second step, reads out comment data correlated with a point of time shown by the comment assignment time, from the plurality of comment information stored in the second comment information storage unit, and displays the read out comment data along with the dynamic image.

8. A computer-readable recording medium storing a program for making a computer included in a comment distribution server that distributes a comment on a dynamic image, function as:
a comment information distribution unit that reads out and distributes a plurality of comment information stored in a comment information storage unit that stores the comment information including: a comment assignment time that is a point of time when comment data is assigned shown by an elapse time from a reproduction start time of the dynamic image data; and the comment data, and being correlated with the dynamic image data.

9. A computer-readable recording medium storing a program for making a computer included in a terminal device that receives and displays dynamic image data and a comment on the dynamic image data, function as:
a dynamic image reproduction unit that receives and reproduces distributed dynamic image data;
a comment information reception unit that receives a plurality of comment information correlated with the dynamic image to be reproduced and stores the plurality of comment information into a comment information storage unit; and
a display unit that displays the dynamic image reproduced by the dynamic image reproduction unit, that reads out comment data correlated with a comment assignment time showing a dynamic image reproduction elapse time of the reproduced dynamic image, from the plurality of comment information stored in the comment information storage unit, and that displays the read out comment data along with the dynamic image.
